(19) United States
(12) Patent Application Publication
(10) Pub. No.: US 2012/0307267 A1
(43) Pub. Date: Dec. 6, 2012

(54) CAPABILITY-BASED CONFIGURATION OF PRINT JOBS

(75) Inventors: Richard Blanchard, JR., Sonoma, CA (US); David Gelphman, Aptos, CA (US); Howard A. Miller, Saratoga, CA (US); Todd W. Ritland, San Francisco, CA (US)

(73) Assignee: APPLE INC., Cupertino, CA (US)

(21) Appl. No.: 13/298,831

(22) Filed: Nov. 17, 2011

Related U.S. Application Data
(60) Provisional application No. 61/493,498, filed on Jun. 5, 2011.

(51) Int. Cl. H04N 1/60; G06F 3/12

(52) U.S. Cl. 358/1.9; 358/1.15

(57) ABSTRACT

The disclosed embodiments provide a system that performs a print job. During operation, the system obtains a printing context for the print job, including a content type associated with the print job and a regional setting. The regional setting may be associated with the application, an operating system, and/or a device associated with the print job. Next, the system obtains a set of capabilities associated with a printer. The system then automatically sets one or more job options for the print job based on the printing context and the set of capabilities, wherein the one or more job options include a media size and a border size. Finally, the system sends the print job to the printer, where the print job is executed using the printer.

### RELATED APPLICATION

This application hereby claims priority under 35 U.S.C. §119 to U.S. Provisional Application No. 61/493,498, entitled “Capability-Based Configuration of Print Jobs,” by Richard Blanchard, Jr., David Gelphman, Howard A. Miller and Todd W. Ritland, filed 5 Jun. 2011 (Atty. Docket No.: APL-P10897USP1).

### BACKGROUND

1. Field

The present embodiments relate to printers for computer systems. More specifically, the present embodiments relate to techniques for configuring print jobs based on the capabilities of printers used to execute the print jobs.

2. Related Art

Printing may facilitate a variety of personal and/or business activities. For example, documents may be printed within a business for design, marketing, accounting, review, recordkeeping, planning, and/or notification purposes. Similarly, a user may print pictures and/or greeting cards for display and/or sharing with friends, family, and/or acquaintances.

However, different types of print settings and/or printer capabilities may be required to produce optimal print output for various types of digital media. For example, a word-processing document may be printed on a laser printer in black-and-white to enhance the readability and/or sharpness of text in the word-processing document. On the other hand, the resolution and/or color gamut of a color photo may be emphasized by printing the color photo on glossy paper using a dye-sublimation printer.

Hence, what is needed is a mechanism for using print settings and/or printer capabilities to enhance print output for various types of digital media.

### SUMMARY

The disclosed embodiments provide a system that performs a print job. During operation, the system obtains a printing context for the print job, including a content type associated with the print job and a regional setting. The regional setting may be associated with the application, an operating system, and/or a device associated with the print job. Next, the system obtains a set of capabilities associated with a printer. The system then automatically sets one or more job options for the print job based on the printing context and the set of capabilities, wherein the one or more job options include a media size and a border size. Finally, the system sends the print job to the printer, where the print job is executed using the printer.

In some embodiments, the regional setting is a language setting and/or a location.

In some embodiments, the capabilities include at least one of a supported media size, a supported border size, a supported resolution, and a supported print quality.

In some embodiments, the one or more job options further include at least one of a resolution and a print quality.

In some embodiments, sending the print job to the printer involves:
(i) providing the media size and the border size to the application;
(ii) obtaining, from the application, print data for the print job based on the media size and the border size; and
(iii) sending the print data and the one or more job options to the printer.

In some embodiments, the content type is at least one of an image, a document, and black-and-white content.

In some embodiments, the one or more job options for the image include at least one of a small media size, borderless printing, a high resolution, and a high print quality.

In some embodiments, the one or more job options for the document include at least one of a large media size, bordered printing, a normal resolution, and a normal print quality.

### BRIEF DESCRIPTION OF THE FIGURES

FIG. 1 shows a printing system in accordance with an embodiment.

FIG. 2 shows a system for performing a print job in accordance with an embodiment.

FIG. 3 shows a flowchart illustrating the process of performing a print job in accordance with an embodiment.

FIG. 4 shows a flowchart illustrating the process of sending a print job to a printer in accordance with an embodiment.

FIG. 5 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for performing a print job. The print job may include print data and/or one or more job options associated with the print data. The print job may be created by a print server and/or other device with functionality to communicate with a printer. After the print job is created, the print server may send the print job to the printer, and the printer may execute the print job by outputting the print data onto sheets of paper according to the job options in the print job.

More specifically, the disclosed embodiments provide a method and system for automatically configuring the print job based on the capabilities of the printer to which the print job is sent. First, a printing context for the print job may be obtained from an application, an operating system and/or a device associated with the print job. The printing context may include a content type that specifies the type of digital media (e.g., image, document, black-and-white content) to be printed using the print job, as well as a regional setting (e.g., language setting, location) associated with the application, the operating system/and or device. Next, a set of capabilities associated with the printer may be obtained. The capabilities may include a supported media size, a supported border size, a supported resolution, and/or a supported print quality.

One or more job options for the print job may then be automatically set based on the printing context and/or capabilities. For example, a media size and border size for the print job may be set based on one or more media and/or border sizes supported by the printer, the content type associated with the print job, and/or the regional setting associated with the application, the operating system/and or the device. Finally, the print job may be sent to the printer, where the print job is executed by the printer.

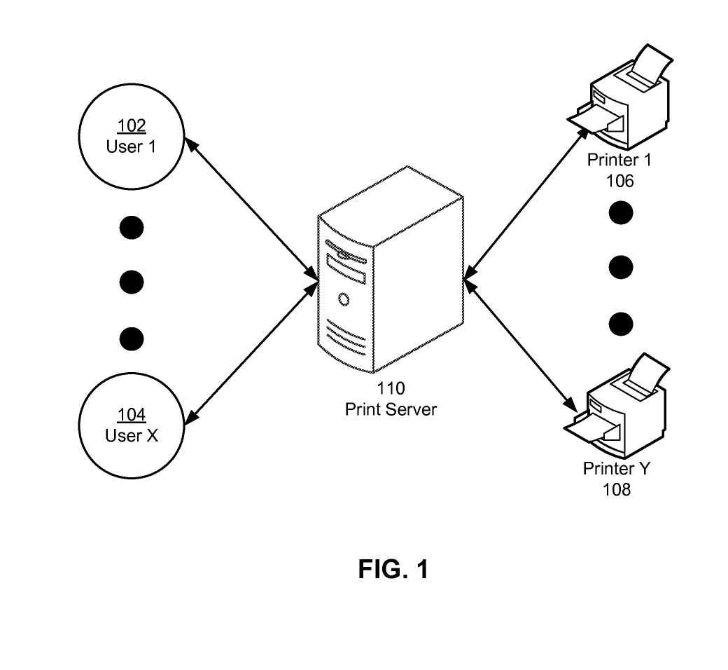

FIG. 1 shows a printing system in accordance with an embodiment. As shown in FIG. 1, the printing system includes a print server 110 and one or more printers (e.g., printer 1 106, printer y 108) connected to print server 110. The printers may correspond to network printers that are connected to print server 110 using a wired or wireless network connection. Alternatively, one or more printers may connect to print server 110 and/or other print servers in the printing system as local peripherals using one or more printer cables and/or one or more ports (e.g., parallel ports, serial ports, Universal Serial Bus (USB) ports).

Print server 110 may process and configure requests for print jobs from one or more users (e.g., user 1 102, user x 104). The users may be associated with access rights to one or more printers connected to print server 110. For example, the users may be associated with user accounts that enable use of one or more printers connected to print server 110.

Upon receiving a request for a print job, print server 110 may send the request to the appropriate printer, which executes the print job using settings provided by the user requesting the print job. For example, the user may select a document and/or image to be printed and one or more job options associated with printing the document and/or image. The job options may include a number of copies, a number of printing sides (e.g., single- or double-sided), collation, stapling, hole punching, an ink set (e.g., black-and-white, color), a media size (e.g., A4, letter), a border size (e.g., bordered, borderless), a toner, a dye, a ribbon, a media type (e.g., glossy, matte, bond, colored), a resolution and/or print quality (e.g., low, medium, high), a page orientation, and/or a printing range (e.g., page range, selection).

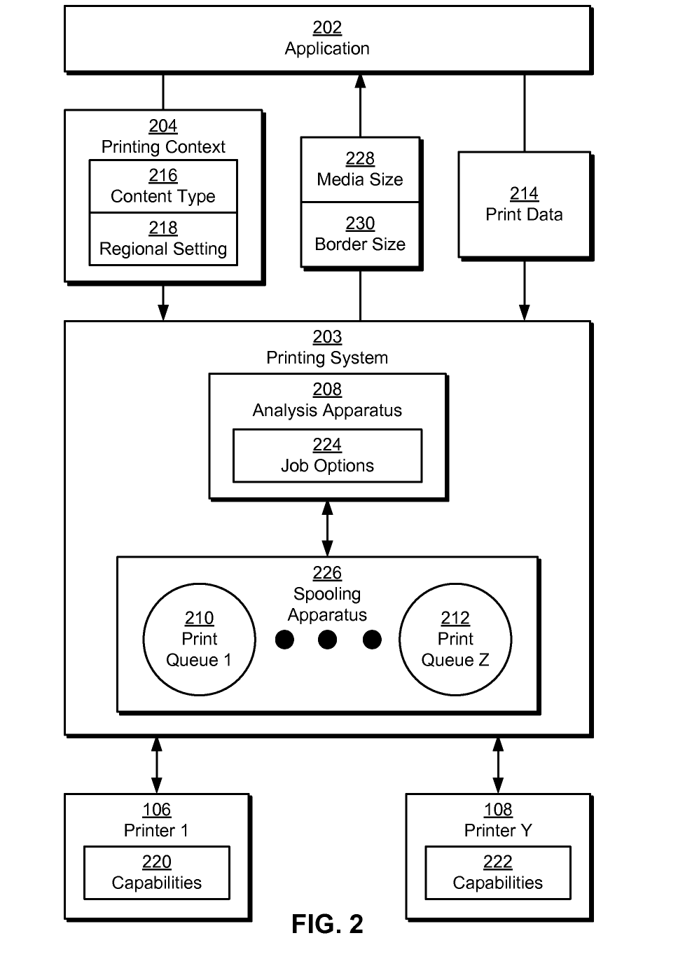

Conversely, print server 110 and/or other components in the printing system may include functionality to automatically configure one or more job options for the print job based on the capabilities of the printer used to execute the print job. As discussed in further detail below with respect to FIG. 2, a printing system 203 associated with print server 110 may obtain a printing context for the print job from an application, an operating system associated with the application, and/or a device on which the application executes. The printing context may include a content type associated with the print job and/or a regional setting associated with the application, the operating system and/or the device. (Also note that printing system 203 generally includes all printing related code which resides outside of an application, including code within print server 110 and code within a device that the application runs on.) Printing system 203 may obtain a set of capabilities associated with a printer in the printing system. The capabilities may include a supported media size, a supported border size, a supported resolution, and/or a supported print quality.

Next, printing system 203 may automatically set one or more job options for the print job based on the printing context and the printer's capabilities. The job options may include a media size, a border size, a resolution, and/or a print quality. For example, printing system 203 may enhance the appearance of a printed image by configuring a print job for the image with a 4×6 media size, borderless printing, a high resolution, and/or a high print quality, if such a configuration is supported by the printer. On the other hand, printing system 203 may configure a print job for a document with an 8½×11 media size, bordered printing, a normal printing quality, and/or a normal resolution because such a configuration may produce print output for the document that is sufficiently sharp to be read by a user.

Finally, printing system 203 may send the print job to the printer. In particular, printing system 203 may provide the media size and border size from the job options to the application, and the application may generate print data for the print job based on the media size and border size. Afterward, printing system 203 may obtain the print data from the application and send the print data and the job option(s) to the printer. Finally, the print job may be executed using the printer. As a result, printing system 203 may utilize the capabilities of the printer to dynamically optimize a print job for a particular printing context.

FIG. 2 shows a system for performing a print job in accordance with an embodiment. As described above, the system may include printing system 203 and/or other components (e.g., computer systems, print servers) associated with printing system 203.

In addition, an application 202 may be configured to communicate with printing system 203. For example, application 202 may execute on a laptop computer, personal computer, mobile phone, tablet computer, and/or other network-enabled electronic device. In turn, application 202 may communicate with printing system 203 using an application programming interface (API) provided by printing system 203 over HyperText Transfer Protocol (HTTP), Internet Printing Protocol (IPP), Line Printer Daemon (LPD) protocol, and/or another network protocol associated with communication in printing system 203.

In particular, application 202 and printing system 204 may enable the printing of digital media. For example, application 202 may provide a user interface (e.g., graphical user interface (GUI)) that allows a user to select one or more documents, images, and/or other files to be included in a print job. Alternatively, application 202 may perform batch-processing operations that create and schedule print jobs in the printing system with little to no user intervention.

After a print job is created, application 202 may send the print job to printing system 203, where the print job is placed into a print queue (e.g., print queue 1 210, print queue z 212) by a spooling apparatus 226. For example, spooling apparatus 226 may assign the print job to a specific printer (e.g., printer 1 106, printer y 108) by placing the print job in the print queue for the printer. When printing system 204 subsequently determines that the printer is not busy, printing system 203 may send the print job to the printer. Alternatively, spooling apparatus 226 may place the print job into a print queue for a printing pool containing multiple physical printers. Once printing system 203 sees that a printer in the printing pool meeting certain criteria is available, printing system 203 may send the print job to the printer. Note the printer can be selected from the printing pool based on the load, availability, capabilities 220-222, and/or other attributes of printers in the printing pool.

As mentioned above, printing system 203 may use capabilities 220-222 of the printers to automatically configure print jobs from application 202. First, printing system 203 may obtain a printing context 204 for each print job from application 202. Conversely, some or all of printing context 204 may be obtained from an operating system and/or device associated with application 202 and/or the print job. Printing context 204 may include a content type 216 associated with the print job. Content type 216 may specify the type of digital media to be printed using the print job. For example, content type 216 may correspond to an image, a document, and/or black-and-white content.

Printing context 204 may also include a regional setting 218. Regional setting 218 may provide location-based information related to application 202, an associated operating system, an associated device, and/or the print job. For example, regional setting 218 may include a language setting for the user interface of application 202 and/or a location of application 202, as provided by a user of application 202 and/or a positioning system (e.g., Global Positioning System) associated with a device on which application 202 is hosted. Alternatively, regional setting 218 may correspond to a geographic region to which the device is set and may be unrelated to the language setting for the user interface of application 202.

Next, printing system 203 may obtain a set of capabilities (e.g., capabilities 220-222) associated with a printer in the printing system. For example, the printer may be selected by the user, application 202, and/or printing system 203 to execute the print job based on load, availability, capabilities 220-222, and/or other attributes associated with the printer. To obtain the printer's capabilities, printing system 203 may query the printer for the capabilities, or printing system 203 may retrieve the printer's capabilities from storage on print server 110, a network associated with printing system 203, and/or another component of the printing system.

In one or more embodiments, the capabilities include a supported media size, a supported border size, a supported resolution, and/or a supported print quality. For example, the printer may include supported media sizes (e.g., paper sizes) of 8½×11 and A4; both bordered and borderless printing; resolutions of 300, 600, and 1200 dots per inch (DPI); and low, medium, and high print qualities. In other words, the capabilities may represent print settings that are supported by the printer.

Printing context 204 and the supported print settings (e.g., capabilities) may then be used by an analysis apparatus 208 in printing system 203 to automatically set one or more job options 224 for the print job. For example, analysis apparatus 208 may facilitate execution of the print job by selecting job options 224 that are both appropriate for printing context 204 and supported by the printer used to execute the print job.

In one or more embodiments, job options 224 include a media size 228 (e.g., paper size) and/or border size 230 (e.g., bordered, borderless) for the print job. For example, analysis apparatus 208 may set a small media size (e.g., 4×6, 5×7) for the print job if content type 216 corresponds to an image and a large media size (e.g., 8½×11, A4) if content type 216 corresponds to a document. Likewise, analysis apparatus 208 may set media size 228 for a document to 8½×11 if regional setting 218 specifies a location and/or language setting associated with North America and to A4 otherwise. Furthermore, if the printer supports both bordered and borderless printing, analysis apparatus 208 may set the border size to borderless if content type 216 corresponds to an image and to bordered if content type 216 corresponds to a document.

Analysis apparatus 208 may also include functionality to set other job options 224, including a resolution and/or a print quality of the print job. If the printer supports multiple resolutions, analysis apparatus 208 may increase the resolution for a print job containing a photo and lower the resolution for a print job containing a document. Similarly, if the printer supports multiple print qualities (e.g., levels of halftoning), analysis apparatus 208 may configure print jobs containing photos to include higher print qualities and print jobs containing documents to include lower print qualities.

Once job options 224 are set, printing system 203 may provide media size 228 and border size 230 to application 202, and application 202 may generate print data 214 for the print job based on media size 228 and border size 230. For example, application 202 may correspond to a web browser that formats a webpage using dimensions provided by media size 228 and/or border size 230 and saves the formatted webpage to a Portable Document Format (PDF) file corresponding to print data 214. Printing system 203 may subsequently obtain print data 214 and send print data 214 and job options 224 to the printer (e.g., through spooling apparatus 226) to enable execution of the print job by the printer. As a result, printing system 203 may utilize the capabilities of the printer to enhance the print output of the print job. Moreover, such enhancement may occur independently of knowledge of the printer by application 202. In other words, the system of FIG. 2 may facilitate the optimization of print output for a variety of applications and/or types of digital media, regardless of the print-related functionality of each of the applications.

Those skilled in the art will appreciate that the system of FIG. 2 may be implemented in a variety of ways. For example, components of application 202 and printing system 203 may reside on the same device (e.g., computer system, electronic device, etc.), or components of application 202 and printing system 203 may execute on different devices and communicate over a network connection. Similarly, analysis apparatus 208 and spooling apparatus 226 may be implemented by the same component and/or different components in printing system 203. In addition, printing system 203 may include functionality to communicate with multiple print servers to enable the processing of print jobs by different sets of printers connected to the print servers.

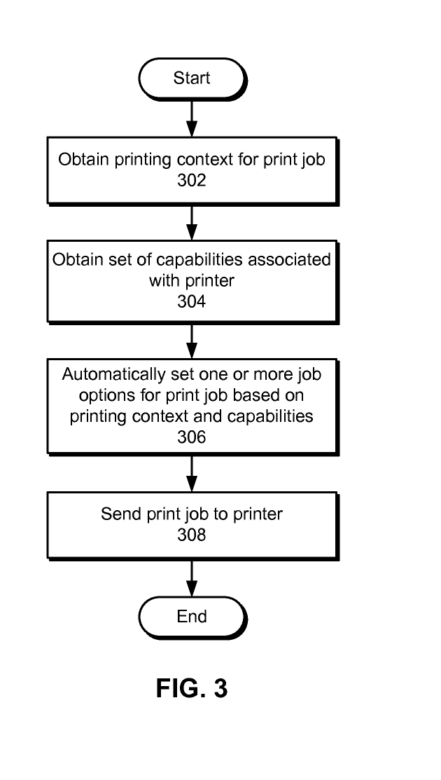

FIG. 3 shows a flowchart illustrating the process of performing a print job in accordance with an embodiment. In one or more embodiments, one or more of the steps may be omitted, repeated, and/or performed in a different order. Accordingly, the specific arrangement of steps shown in FIG. 3 should not be construed as limiting the scope of the technique.

Initially, a printing context for the print job is obtained from an application, an operating system and/or a device (operation 302). The application may be used to generate the printing context and/or request the print job. The printing context may specify a content type associated with the print job, such as a document, image, and/or black-and-white content. The printing context may also specify a regional setting associated with the application, the operating system and/or the device, such as a language setting and/or a location.

Next, a set of capabilities associated with a printer is obtained (operation 304). The capabilities may include a supported media size, a supported border size, a supported resolution, and/or a supported print quality. In addition, the capabilities may be obtained from the printer and/or from a component in a printing system associated with the printer.

One or more job options for the print job are set based on the printing context and the set of capabilities (operation 306). The job options may specify a media size and border size for the print job. The job options may also include a resolution and/or a print quality for the print job. For example, job options for an image may include a small media size (e.g., 4×6, 5×7), borderless printing, a high resolution, and/or a high printing quality. On the other hand, job options for a document may include a large media size (e.g., 8½×11, A4), bordered printing, a normal resolution, and/or a normal printing quality.

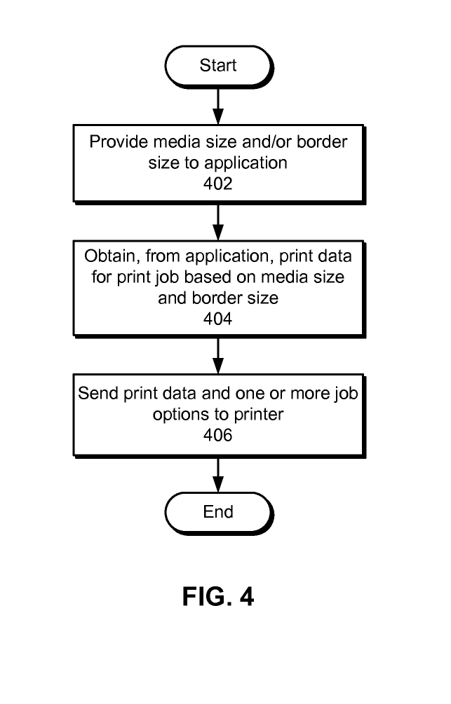

Finally, the print job is sent to the printer (operation 308). For example, the print job may be placed in a print queue for the printer to be subsequently sent to the printer once the printer is ready to start the print job. The sending of print jobs to printers is discussed in further detail below with respect to FIG. 4.

FIG. 4 shows a flowchart illustrating the process of sending a print job to a printer in accordance with an embodiment. In one or more embodiments, one or more of the steps may be omitted, repeated, and/or performed in a different order. Accordingly, the specific arrangement of steps shown in FIG. 4 should not be construed as limiting the scope of the technique.

First, a media size and border size are provided to an application (operation 402). The media size may be selected from a set of supported media sizes for the printer. For example, the media size may be 4×6, 5×7, 8½×11, A4, and/or 11×13. Next, print data for the print job based on the media size and border size is obtained from the application (operation 404). For example, the application may generate the print data by laying out an image and/or document within the dimensions specified by the media size and border size. Finally, the print data and one or more job options for the print job are sent to the printer (operation 406) for execution of the print job. The print data and/or job options may be dynamically optimized for a particular printing context within the capabilities of the printer used to execute the print job.

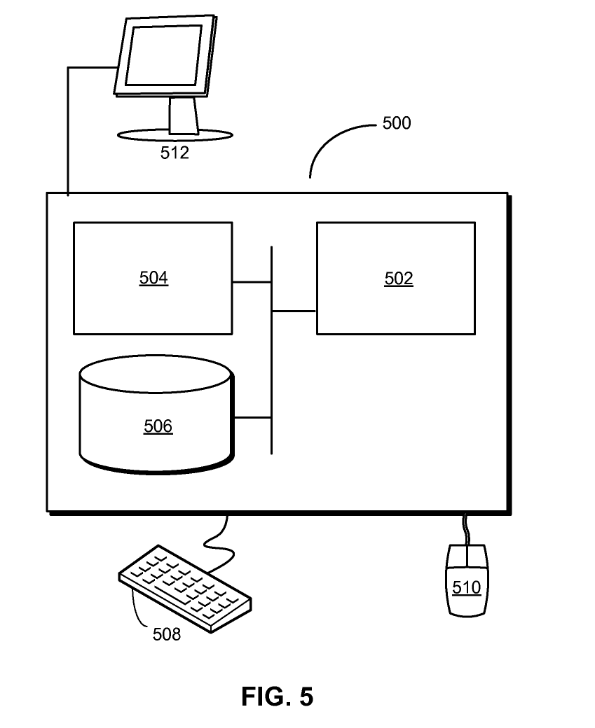

FIG. 5 shows a computer system 500 in accordance with an embodiment. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for performing a print job. The system may include an analysis apparatus that obtains, from an application, operating system and/or device, a printing context for the print job, including a content type associated with the print job. The analysis apparatus may also obtain a set of capabilities associated with a printer. The analysis apparatus may then automatically set one or more job options for the print job, including a media size and border size, based on the printing context and the set of capabilities. The system may also include a spooling apparatus that sends the print job to the printer, where the print job is executed using the printer.

In addition, one or more components of computer system 500 may be remotely located and connected to the other components over a network. Portions of the present embodiments (e.g., analysis apparatus, spooling apparatus, etc.) may also be located on different nodes of a distributed system that implements the embodiments. For example, the present embodiments may be implemented using a cloud computing system that manages the use of a set of remote printers by a set of users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for performing a print job, comprising:
obtaining a printing context for the print job, wherein the printing context comprises,
a content type associated with the print job, and
a regional setting;
obtaining a set of capabilities associated with a printer;
automatically setting one or more job options for the print job based on the printing context and the set of capabilities, wherein the one or more job options comprise a media size and a border size; and
sending the print job to the printer, wherein the print job is executed using the printer.

2. The computer-implemented method of claim 1, wherein the regional setting is at least one of a language setting and a location.

3. The computer-implemented method of claim 1, wherein the capabilities comprise at least one of a supported media size, a supported border size, a supported resolution, and a supported print quality.

4. The computer-implemented method of claim 1, wherein the one or more job options further comprise at least one of a resolution and a print quality.

5. The computer-implemented method of claim 1, wherein sending the print job to the printer involves:
providing the media size and the border size to the application;
obtaining, from the application, print data for the print job based on the media size and the border size; and
sending the print data and the one or more job options to the printer.

6. The computer-implemented method of claim 1, wherein the content type is at least one of an image, a document, and black-and-white content.

7. The computer-implemented method of claim 6, wherein the one or more job options for the image comprise at least one of:
a small media size;
borderless printing;
a high resolution; and
a high print quality.

8. The computer-implemented method of claim 6, wherein the one or more job options for the document comprise at least one of:
a large media size;
bordered printing;
a normal resolution; and
a normal print quality.

9. A system for performing a print job, comprising:
an analysis apparatus configured to:
obtain a printing context for the print job, wherein the printing context comprises,
a content type associated with the print job, and
a regional setting;
obtain a set of capabilities associated with a printer; and
automatically set one or more job options for the print job based on the printing context and the set of capabilities, wherein the one or more job options comprise a media size and a border size; and
a spooling apparatus configured to send the print job to the printer, wherein the print job is executed using the printer.

10. The system of claim 9, wherein the capabilities comprise at least one of a supported media size, a supported border size, a supported resolution, and a supported print quality.

11. The system of claim 9, wherein the one or more job options further comprise at least one of a resolution and a print quality.

12. The system of claim 9, wherein sending the print job to the printer involves:
providing the media size and the border size to the application;
obtaining, from the application, print data for the print job based on the media size and the border size; and
sending the print data and the one or more job options to the printer.

13. The system of claim 9, wherein the content type is at least one of an image, a document, and black-and-white content.

14. The system of claim 13, wherein the one or more job options for the image comprise at least one of:
a small media size;
borderless printing;
a high resolution; and
a high print quality.

15. The system of claim 13, wherein the one or more job options for the document comprise at least one of:
a large media size;
bordered printing;
a normal resolution; and
a normal print quality.

16. A computer-readable storage medium storing instructions that when executed by a computer cause the computer to perform a method for performing a print job, the method comprising:
obtaining a printing context for the print job, wherein the printing context comprises,
a content type associated with the print job, and
a regional setting;
obtaining a set of capabilities associated with a printer;
automatically setting one or more job options for the print job based on the printing context and the set of capabilities, wherein the one or more job options comprise a media size and a border size; and
sending the print job to the printer, wherein the print job is executed using the printer.

17. The computer-readable storage medium of claim 16, wherein the capabilities comprise at least one of a supported media size, a supported border size, a supported resolution, and a supported print quality.

18. The computer-readable storage medium of claim 16, wherein the one or more job options further comprise at least one of a resolution and a print quality.

19. The computer-readable storage medium of claim 16, wherein sending the print job to the printer involves:
providing the media size and the border size to the application;
obtaining print data for the print job based on the media size and the border size; and
sending the print data and the one or more job options to the printer.

20. The computer-readable storage medium of claim 16, wherein the content type is at least one of an image, a document, and black-and-white content.

21. The computer-readable storage medium of claim 20, wherein the one or more job options for the image comprise at least one of:
a small media size;
borderless printing;
a high resolution; and
a high print quality.

22. The computer-readable storage medium of claim 20, wherein the one or more job options for the document comprise at least one of:
a large media size;
bordered printing;
a normal resolution; and
a normal print quality.
